(19) United States
(12) Patent Application Publication
(10) Pub. No.: US 2011/0224323 A1
(43) Pub. Date: Sep. 15, 2011

(54) POLYESTERS, METHODS OF THEIR PREPARATION AND USE

(76) Inventors: Michael P. Bigwood, Oreland, PA (US); Linda S. Smith, Oreland, PA (US); Michael C. Bigwood, Oreland, PA (US)

(21) Appl. No.: 13/130,225

(22) PCT Filed: Nov. 20, 2009
(86) PCT No.: PCT/US09/65297

§ 371 Date: May 19, 2011

Related U.S. Application Data
(60) Provisional application No. 61/199,816, filed on Nov. 20, 2008.

(51) Int. Cl. C08G 63/12; C08G 63/52; C08L 67/04

(52) U.S. Cl. 521/182; 528/296; 528/306; 524/600

(57) ABSTRACT

Crosslinked polycondensation products of: (a) polyols selected from the group consisting of: (1) polyols with three or more hydroxyl groups, (2) acetal forms of (1), and (3) mixtures thereof, and (b) polyacids selected from the group consisting of: (1) polyacids with two or more carboxylic groups, (2) anhydrides of (1), (3) esters of (1), and (4) mixtures thereof are disclosed. The resulting polyesters have a molar ratio of polyol to polyacid from about 1:3 to about 3:1 and are highly-crosslinked. Preferred monomers are sustainable monomers such as glycerol, citric acid, fumaric acid, and sebacic acid. Two-step heating processes for preparing the high molecular weight polyesters are also provided.

### CROSS REFERENCE TO RELATED APPLICATION

This application claims the benefit of priority to U.S. Patent App. Ser. No. 61/199,816 filed Nov. 20, 2008, which is incorporated herein by reference in its entirety.

### FIELD OF THE INVENTION

The present invention relates to polyesters that are the crosslinked polycondensation products of a polyol and a polyacid and methods of their production and use. Preferred polyols and polyacids are sustainable monomers obtained from renewable resources. The crosslinked polycondensation products are formed through a process involving prepolymer formation at a first temperature and then curing the prepolymer by self-crosslinking at a second, higher temperature, or by the addition of a crosslinking agent or a polymerization catalyst at a second temperature. The prepolymer may be stored as a liquid, a solution, a suspension, or as a hardened polymer and then placed in a reactor, such as a heated mold, for curing into the desired shaped article at the second temperature.

### BACKGROUND OF THE INVENTION

It is desirable to use sustainable monomers in polymer production to avoid the economic and environmental problems associated with monomers produced through petroleum fractionation and manufacturing. Sustainable monomers are those monomers that can be manufactured from a readily renewable resource without reliance on fossil fuels as the source of the starting material. For example, the triol glycerol and the triacid citric acid can both be obtained from natural sources without using fossil fuels as a starting material.

Polyesters formed from glycerol and certain diacids have been disclosed. US Patent Application Pub. No. 2003/0118692, published Jun. 26, 2003, discloses polycondensation of glycerol and sebacic acid at 120° C. under argon for 24 hours before the pressure was reduced from 1 Torr to 40 mTorr over five hours. The reaction mixture was kept at 40 mTorr and 120° C. for 48 hours. The resulting polyester was reported to be an elastomer that did not swell or dissolve in water. US2003/0118692 also discloses that this elastomer is a thermoset polymer and that the uncrosslinked prepolymer can be processed into various shapes by curing under vacuum in a mold, such as at 120° C. and 100 mTorr.

U.S. Pat. No. 7,557,167, issued Jul. 7, 2009, discloses crosslinked polymers produced from a polyol and a saturated aliphatic diacid. The polyol may be glycerol with or without ethylene glycol and the diacid may be sebacic acid. The polyester preferably exhibits shape memory properties.

Copolymerization reactions involving glycerol and naturally occurring polycarboxylic acids, such as citric acid, and an acid catalyst, such as para-toluene sulfonic acid, are known. See, e.g., U.S. Pat. Nos. 3,978,203; U.S. Pat. No. 5,480,963; and D. Pramanick and T. T. Ray, “Synthesis and Biodegradation of Copolyesters from Citric Acid and Glycerol,” Polymer Bulletin 19, 365-370 (1988). The polymerization of glycerol with a tricarboxylic acid (trimellitic acid) using a temperature profile involving four different temperatures has been reported. D. Pramanick et al., “Copolyester of Trimellitic Acid, Glycerol, and Poly(ethylene glycol): Synthesis and Characterization,” J. Appl. Polm. Sci 91, pp. 343-346 (2004). Glass transition temperatures for these polymers have been reported to be generally at or below room temperature. For example, D. Pramanick and T. T. Ray, “Synthesis and Biodegradation of Copolyesters from Citric Acid and Glycerol,” Polymer Bulletin 19, 365-370, 368 (1988), discloses polymers made from citric acid and glycerol having glass transition temperatures ranging from 6° C. to 22° C.

Glycerol and citric acid have been used in low amounts as branching agents for otherwise straight chain polymers. The addition of these branching agents is typically limited to less than five (5) mol % of the total polyester composition.

For many industrial applications, such as coatings, foams, films, bottles and adhesives, high molecular weight polymers with good water and solvent resistance are desirable. Various processes have been developed to increase the molecular weight of polyesters and thus increase their commercial usefulness. These reactions typically produce high molecular weight linear polyesters that rely on intermolecular forces for their physical properties. These polyesters are typically thermoplastic, rather than thermoset. Thermoplastics are polymers held together by intermolecular forces rather than chemical bonds between the polymer molecules. In contrast, thermosets have one or more chemical bonds (crosslinks) binding the polymer molecules together.

In some cases, obtaining high molecular weight polymers requires expensive processing equipment. For example, processes for producing high molecular weight polylactic acid (PLA) and polyglycolic acid (PGA) are well known. Both PLA and PGA are produced from sustainable starting materials—lactide and glycolide, respectively. However, forming high molecular weight polyesters from either monomer requires a complex ring-opening polymerization process to prevent the water formed during the reaction from dissolving the polymer as it is formed.

Transesterification has been used to increase the molecular weight of polyesters. In traditional condensation polymerization, a carboxylic acid or its anhydride is reacted with an alcohol containing two or more hydroxyl groups at high temperature and under vacuum. In transesterification reactions, often a methyl ester is the starting material. Because the starting material contains a methyl group, rather than a hydroxyl group, the reaction produces methanol, rather than water, as a byproduct. Methanol has a lower boiling point than water and is thus easier to remove. Again, these polyesters are typically straight chain thermoplastics. For example, polyethylene terephthalate (PET), a widely used polyester, is produced by reacting ethylene glycol with methyl terephthalate in a two step transesterification process. In the first step, the ethylene glycol and the methyl terephthalate are reacted at temperatures ranging from 150° C. to 200° C. and the methanol byproduct is removed by continuous distillation. In the second step, the mixture is heated to a temperature between 260° C. to 290° C. and ethylene glycol is continuously removed to allow the reaction to proceed.

It is also known in the art that the molecular weight of polyesters may be increased by increasing the reaction temperature in multiple steps. Typically, these reactions are at low temperatures under vacuum. They often require more than two temperature steps and are completed in a single reactor without time between the temperature steps.

It is an object of the invention to provide polyesters produced from sustainable monomers that have the high mechanical performance associated with high molecular weight polyesters. Furthermore, it is another object to provide a process for producing such polyesters that is economical and can be performed under standard conditions with standard equipment.

### BRIEF SUMMARY OF THE INVENTION

In one aspect, the invention provides a crosslinked polycondensation product of (a) one or more polyols selected from the group consisting of: (1) polyols with three or more hydroxyl groups, (2) acetal forms of (1), and (3) mixtures thereof, and (b) one or more polyacids selected from the group consisting of: (1) polyacids with two or more carboxylic groups, (2) anhydrides of (1), (3) esters of (1), and (4) mixtures thereof; in which the molar ratio of polyol to polyacid is from about 1:3 to about 3:1; and the crosslinked polycondensation product is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or by a glass transition temperature from about 50° C. to about 150° C.

The present invention also provides a method for preparing a crosslinked polyester comprising: (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1; (b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer; (c) optionally mixing the low molecular weight prepolymer with a modification compound selected from the group consisting of: (1) polymer additives, (2) plasticizers, (3) foam blowing agents, and (4) mixtures thereof, to form a second mixture; (d) reacting either (1) the low molecular weight prepolymer or (2) the second mixture by heating at a pressure at or above about one (1) atmosphere and at a temperature from about 175° C. to about 400° C. for a period of time from about three (3) seconds to about sixty (60) minutes to form the crosslinked polyester.

In another aspect, the invention provides a method for preparing a crosslinked polyester by use of a crosslinking agent in addition to the polyol and polyacid. This aspect provides a method comprising (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1; (b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer; (c) optionally mixing the low molecular weight prepolymer with a modification compound selected from the group consisting of: (1) polymer additives, (2) plasticizers, (3) foam blowing agents, and (4) mixtures thereof, to form a second mixture; (d) mixing either (1) the low molecular weight prepolymer or (2) the second mixture with a crosslinking agent and curing at a pressure at or above about one (1) atmosphere and at a temperature from about 20° C. to about 130° C. for a period of time from about thirty (30) seconds to about sixty (60) minutes to form the crosslinked polyester.

In another aspect, the invention provides a method for preparing a crosslinked polyester by use of a polymerization catalyst in addition to the polyol and polyacid. This aspect provides a method comprising (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1; (b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer; (c) optionally mixing the low molecular weight prepolymer with a modification compound selected from the group consisting of: (1) polymer additives, (2) plasticizers, (3) foam blowing agents, and (4) mixtures thereof, to form a second mixture; (d) mixing either (1) the low molecular weight prepolymer or (2) the second mixture with a polymerization catalyst and curing at a pressure at or above about one (1) atmosphere and at a temperature from about 130° C. to about 250° C. for a period of time from about thirty (30) seconds to about sixty (60) minutes to form the crosslinked polyester.

In another aspect, the invention provides a method of forming a shaped polyester article comprising (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1; (b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer; (c) cooling the resulting low molecular weight prepolymer to ambient conditions; (d) heating the cooled low molecular weight prepolymer to a temperature above the gel point of the prepolymer until the low molecular weight prepolymer is flowable; (e) optionally mixing the flowable low molecular weight prepolymer with a modification compound selected from the group consisting of: (1) polymer additives, (2) plasticizers, (3) foam blowing agents, and (4) mixtures thereof to form a polymer mixture; and (f) reacting either (1) the flowable low molecular weight prepolymer or (2) the polymer mixture by heating at a pressure at or above about one (1) atmosphere and at a temperature from about 175° C. to about 400° C. for a period of time from about three (3) seconds to about sixty (60) minutes in a mold, extruder, film casting equipment, spray gun, or other shape-forming or thermoforming equipment to form the shaped polyester article.

In a further embodiment, the invention provides a method of making a shaped polyester article using a crosslinking agent in addition to the polyol and polyacid. This embodiment is a method comprising (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1; (b) reacting the first mixture from step (a) at a pressure at or above about one (1) atmosphere and at a temperature from about 80° C. to about 250° C. for a period of time from about fifteen (15) minutes to about three hundred (300) minutes to form a low molecular weight prepolymer; (c) cooling the resulting low molecular weight prepolymer to ambient conditions; and (d) heating the cooled low molecular weight prepolymer to a temperature above the gel point of the prepolymer until the low molecular weight prepolymer is flowable; (e) optionally mixing the flowable low molecular weight prepolymer with a modification compound selected from the group consisting of: (1) polymer additives, (2) plasticizers, (3) foam blowing agents, and (4) mixtures thereof to form a polymer mixture; and (f) reacting either (1) the flowable low molecular weight prepolymer or (2) the polymer mixture with a crosslinking agent at a pressure at or above about one (1) atmosphere and at a temperature from about 20° C. to about 130° C. for a period of time from about thirty (30) seconds to about sixty (60) minutes in a mold, extruder, film casting equipment, spray gun, or other shape-forming or thermoforming equipment to form the shaped polyester article.

In a further embodiment, the invention provides a method of making a shaped polyester article using a polymerization catalyst in addition to the polyol and polyacid. This embodiment is a method comprising (a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1; (b) reacting the first mixture from step (a) at a pressure at or above about one (1) atmosphere and at a temperature from about 80° C. to about 250° C. for a period of time from about fifteen (15) minutes to about three hundred (300) minutes to form a low molecular weight prepolymer; (c) cooling the resulting low molecular weight prepolymer to ambient conditions; and (d) heating the cooled low molecular weight prepolymer to a temperature above the gel point of the prepolymer until the low molecular weight prepolymer is flowable; (e) optionally mixing the flowable low molecular weight prepolymer with a modification compound selected from the group consisting of: (1) polymer additives, (2) plasticizers, (3) foam blowing agents, and (4) mixtures thereof to form a polymer mixture; and (f) reacting either (1) the flowable low molecular weight prepolymer or (2) the polymer mixture with a polymerization catalyst at a pressure at or above about one (1) atmosphere and at a temperature from about 130° C. to about 250° C. for a period of time from about thirty (30) seconds to about sixty (60) minutes in a mold, extruder, film casting equipment, spray gun, or other shape-forming or thermoforming equipment to form the shaped polyester article.

### DETAILED DESCRIPTION OF THE INVENTION

As used herein, the singular terms “a” and “the” are synonymous and used interchangeably with “one or more” or “at least one” unless the context clearly indicates a contrary meaning. For all the compositions and processes included herein, it should be understood that there will be at least trace amounts of the unreacted constituent components, including any monomers and polymer reaction catalysts used. Unless otherwise indicated, all percentages are weight percentages and all ratios are molar ratios.

The term “polyol” refers to any molecule with two or more hydroxyl groups, including acetal forms of these molecules. The term “polyacid” refers to any carboxylic acid bearing two or more carboxylic groups, including anhydride and ester forms of these molecules. The term “prepolymer” refers to the polymer created after the initial heating step of the invention and the terms “final polymer,” “cured polymer,” or “crosslinked polyester” refer to the high molecular weight, crosslinked polymer created after the second step of the invention when the prepolymer is raised to a second temperature. The term “glass transition temperature” (Tg) refers to the temperature at which a polymer transitions from a relatively rigid, inflexible state to a less rigid, flexible state. The term “general insolubility” means that a substance has not begun to dissolve when immersed in a solvent for twenty-four (24) hours.

Compositions and processes in accordance with the various embodiments of the present invention are suitable for use in making a wide array of finished shaped products and articles of manufacture that require a rigid or semi-rigid form and that also require resistance to water and other solvents. The present invention includes a high molecular weight polymer that is highly crosslinked and that exhibits resistance to water and other solvents. Also included in the present invention is a method of making the high molecular weight polymers that are highly crosslinked and a method of forming shaped products and articles of manufacture using the cured high molecular weight polymer.

The cured high molecular weight, highly crosslinked polyesters of the present invention do not require special processing conditions (such as being conducted under vacuum pressure) to remove water and react at lower temperatures than those known in the art. These stable, cured, high molecular weight, highly crosslinked polyesters can be prepared by a step-wise reaction method. The method comprises two steps. In the first step, low molecular weight polyester prepolymers are synthesized by (i) reacting one or more polyols, or acetals of these polyols, with one or more polyacids, or anhydrides or esters of these polyacids, at a pressure at or above about one (1) atmosphere and at a temperature from about 80° C. to about 250° C. for a time from about fifteen (15) minutes to about three hundred (300) minutes.

If the polymerization reaction forms water as a byproduct, it is preferred that the reaction temperature be above about 100° C. to allow the water to evaporate. Preferably, the reaction occurs at a temperature range from about 110° C. to about 250° C. This first step of the reaction may occur at a temperature range from about 110° C. to about 150° C., about 120° C. to about 140° C., about 130° C. to about 180° C., about 140° C. to about 170° C., about 130° C. to about 160° C., about 140° C. to about 160° C., about 140° C. to about 190° C., about 130° C. to about 180° C., about 150° C. to about 200° C., about 160° C. to about 200° C., about 170° C. to about 200° C., about 180° C. to about 200° C., about 190° C. to about 220° C., about 200° C. to about 230° C., about 210° C. to about 240° C., or about 160° C. to about 240° C. When the polyacid is a triacid, the preferred temperatures are lower than when the polyacid is a diacid.

It is preferred that the first step prepolymer reaction not be catalyzed with any esterification catalyst, including, but not limited to, sulfuric, methyl sulfonic, benzyl sulfonic, para-toluene sulfonic, boric, and phosphoric acids.

In the second step, the low molecular weight prepolymers are further reacted to form a final cured polymer that has a high molecular weight and is highly crosslinked. Before the second reaction step, the prepolymer may be mixed with one or more polymer modification compounds, including, but not limited to, polymer additives, plasticizers, and foam blowing agents. The prepolymer or the prepolymer mixture is then cured in a further reaction step at a pressure at or above about one (1) atmosphere and a temperature from about 175° C. to about 400° C. for a period of time from about three (3) seconds to about sixty (60) minutes. In certain embodiments, this curing step occurs at a pressure at or above about one (1) atmosphere and a temperature from about 175° C. to about 300° C., about 190° C. to about 300° C., about 190° C. to about 200° C., about 200° C. to about 300° C., about 250° C. to about 300° C., about 175° C. to about 250° C., about 175° C. to about 220° C., about 200° C. to about 400° C., about 250° C. to about 400° C., or about 300° C. to about 400° C. for a period of time from about five (5) seconds to about sixty (60) minutes, about thirty (30) seconds to about sixty (60) minutes, about five (5) minutes to about sixty (60) minutes, about twenty (20) minutes to about sixty (60) minutes, about forty (40) minutes to about sixty (60) minutes, about five (5) seconds to about thirty (30) minutes, about two (2) minutes to about thirty (30) minutes, about five (5) minutes to about thirty (30) minutes, about three (3) seconds to about forty-five (45) minutes, about fifteen (15) minutes, about fifteen (15) minutes to about sixty (60) minutes, about twenty (20) minutes to about forty-five (45) minutes, about fifteen (15) minutes to about forty-five (45) minutes, about twenty (20) minutes to about thirty (30) minutes, or about five (5) minutes to about forty-five (45) minutes.

Alternatively, if lower temperature curing is desired, a crosslinking agent or a polymerization catalyst may be used. Any crosslinking agent that contains two or more functional groups that can react with either the hydroxyl or carboxylic groups of the prepolymers may be used, including, but not limited to, (1) aromatic diisocyanates, (2) aliphatic diisocyanates, (3) polymeric diisocyanates, (4) cycloaliphatic diepoxides, (5) aromatic diepoxides, (6) diepoxides with oxyalkyl backbones, (7) 2,2,4-trimethyl-1,3-pentane diol monoisobutylate, (8) glycerin, (9) trimethylol propane, and (10) mixtures thereof.

The addition of the crosslinking agent allows for curing at temperatures from about 20° C. to about 130° C. at or above one (1) atmosphere pressure for about thirty (30) seconds to about sixty (60) minutes. In certain embodiments, the second step of the polymerization with a crosslinking agent occurs at or above one (1) atmosphere and occurs at a temperature of about 20° C. to about 50° C., about 30° C. to about 60° C., about 40° C. to about 70° C., about 50° C. to about 80° C., about 60° C. to about 90° C., about 70° C. to about 100° C., about 80° C. to about 110° C., about 90° C. to about 120° C., about 100° C. to about 130° C., or about 60° C. to about 130° C. for a period of about thirty (30) seconds to about thirty (30) minutes, about one (1) minute to about thirty (30) minutes, about five (5) minutes to about thirty (30) minutes, about fifteen (15) minutes to about thirty (30) minutes, about five (5) minutes to about sixty (60) minutes, about ten (10) minutes to about sixty (60) minutes, or about thirty (30) minutes to about sixty (60) minutes. When an epoxide crosslinking agent is used, the prepolymer may be cured to the final polymer at ambient conditions. This is especially useful for coating and adhesive applications. One or more crosslinking agents may be used.

Polymerization catalysts that may be used in the second heating step include, but are not limited to, (1) sulfuric acid, (2) phenylsulfonic acid, (3) benzene sulfonic acid, and (4) para-toluene sulfonic acid (“pTSA”). The addition of the polymerization catalyst allows for curing at temperatures from about 130° C. to about 250° C. at or above one (1) atmosphere pressure for about thirty (30) seconds to about sixty (60) minutes. For example, the reaction time required for the second step may be decreased to a period of about five (5) minutes by the addition of pTSA without negatively affecting the degree of crosslinking or other final polymer properties. One or more polymerization catalysts may be used.

In certain embodiments, the second step of the polymerization with a polymerization catalyst occurs at or above one (1) atmosphere and occurs at a temperature of about 130° C. to about 160° C., about 140° C. to about 170° C., about 150° C. to about 180° C., about 160° C. to about 190° C., about 170° C. to about 200° C., about 150° C. to about 200° C., about 130° C. to about 180° C., about 180° C. to about 230° C., about 190° C. to about 240° C., about 200° C. to about 240° C., or about 140° C. to about 200° C., for a period of about thirty (30) seconds to about thirty (30) minutes, about one (1) minute to about thirty (30) minutes, about five (5) minutes to about thirty (30) minutes, about fifteen (15) minutes to about thirty (30) minutes, about five (5) minutes to about sixty (60) minutes, about ten (10) minutes to about sixty (60) minutes, or about thirty (30) minutes to about sixty (60) minutes.

The resulting polymer condensation product exhibits a high molecular weight and is highly crosslinked, as may be evidenced by general insolubility in one or more solvents, including, but not limited to, water, acetone, methyl ethyl ketone (MEK), tetrahydrofuran, dimethylformamide, and dichloromethane. General insolubility in a solvent may be demonstrated by generally accepted methods. One method is to immerse a sample of a substance into the solvent and observe the material over time to detetmine if it dissolves. Another method is to measure one or more dimensions of a polymer sample before immersion, then to measure the polymer sample after set time periods to determine if there has been a change in the specific dimension, which may then be expressed as a percentage. For purposes of the invention, the time period used to determine general insolubility is twenty-four (24) hours.

The resulting cured polymer has a Tg measurement that will fall within the range of from about 50° C. to about 150° C. In certain embodiments, the Tg is from about 50° C. to about 80° C., from about 60° C. to about 90° C., from about 70° C. to about 100° C., from about 80° C. to about 110° C., from about 90° C. to about 120° C., from about 100° C. to about 130° C., from about 80° C. to about 120° C., from about 110° C. to about 140° C., from about 120° C. to about 140° C., or from about 130° C. to about 150° C. This Tg is significantly higher than those disclosed in the prior art. See, for example, D. Pramanick and T. T. Ray, “Synthesis and Biodegradation of Copolyesters from Citric Acid and Glycerol,” Polymer Bulletin 19, 365-370, 368 (1988), which discloses Tg measurements for citric acid/glycerol polymers that range between 6° C. and 22° C. As illustrated in Example 3, the Tg measurements for citric acid/glycerol polymers of the present invention range from 106° C. to 140° C. As illustrated in the Examples set out below, the Tg for the cured polymer is higher than the Tg of the prepolymer. For reference, both polystyrene and methyl methacrylate have glass transition temperatures of about 100° C. Additionally, the resulting cured polymer of the invention is not an elastomer.

During the second heating step, the copolymer can be thermoset into a variety of final products or articles of manufacture by curing the polymer using molds (such as molds fired in ovens, mold casting equipment, or injection molds), extruders, film casting equipment, spray guns, or other shape-forming or thermoforming equipment.

The properties of the prepolymer, and thus the cured polymer, may be manipulated by varying the molar ratio of polyol to polyacid. In the present invention, the polyol:polyacid molar ratio may range from about 1:3 to about 3:1. To achieve the highest potential for crosslinking in the cured polymer, the initial polyol:polyacid molar ratio is about 1:1. If a more flowable prepolymer is desired, the polyol:polyacid molar ratio is increased to a range from about 1:1 to about 3:1. If a harder (less flowable) prepolymer is desired, the polyol:polyacid molar ratio may be decreased to a range from about 1:1 to about 1:3. In other embodiments, the molar ratio of polyol:polyacid is about 1:2 to about 2:1; or about 1:1.5 to about 1.5:1.

For purposes of the invention, the polyol may be any molecule with three or more hydroxyl groups, including, but not limited to linear or cyclic (C₁-C₆) trihydroxy alkanes, linear or cyclic (C₁-C₆) trihydroxy alkenes, including the acetal forms of these molecules. Preferably, the polyol is one or more of the following: glycerol, isopropylidene glycerol (solketal), pentaerythritol, 1,2,4-bunatetriol, and their acetal forms. For purposes of the present invention, naturally occurring, sustainable polyols are preferred, including, but not limited to, glycerol.

The polyacid may be any molecule with two or more carboxylic groups, including, but not limited to, linear dicarboxylic acids where the acid groups are separated by an aliphatic chain of variable length (for example, succinic, adipic, and sebacic acids), unsaturated hydrocarbon chains of various lengths (for example, fumaric acid), dicarboxylic acids containing a saturated or aromatic ring (for example, phthalic and terephthalic acids), and linear or cyclic, aliphatic or unsaturated tricarboxylic acids (for example, citric and trimellitic acids), and anhydrides and esters of these carboxylic acids. For purposes of the present invention, naturally occurring, sustainable polyacids are preferred, including, but not limited to adipic, succinic, citric, cis-aconitic, isocitric, alpha-ketoglutaric, fumaric, maleic, sebacic, and oxalacetic acids. In one embodiment, the polyacid is an aliphatic diacid, anhydride, or ester thereof.

In one embodiment the polyol is glycerol or its acetal and the polyacid is citric acid, its anhydride, or its esters. Both glycerol and citric acid are non-toxic, sustainable starting materials; thus, prepolymers and cured polymers resulting from glycerol and citric acid have the advantage of being produced from sustainable materials.

In another embodiment, the cured polymer does not include a diol, such as ethylene glycol, and the inventive methods do not include polymerization of polyol and polyacid with a diol, especially with ethylene glycol. In yet another embodiment, the cured polymer is not made from a mixture of sebacic acid and glycerol, and the inventive methods do not include polymerization of sebacic acid and glycerol.

In the second heating step, the prepolymers may be self-crosslinked to form the cured polymer by additional heating of the prepolymers. Typical applications for the self-crosslinked cured polymer include foams, including, but not limited to, packaging materials; flexible and semi-flexible films; and thermoset formed products.

Although the second heating step of the present invention does not necessarily require foam blowing agents to form a foamed cured polymer, blowing agents may be used. These blowing agents, include, but are not limited to, carbon dioxide, water vapor, carbonate salts, isocyanate, gaseous hydrocarbons, halogenated hydrocarbons, and alcohols. When water is used as a blowing agent, the resulting cured polymer foam exhibits a low density. In certain embodiments, the foam blowing agents do not include porogens, such as sodium chloride.

In addition to foam blowing agents, plasticizers, including, but not limited to linear (C₁-C₆) or cyclic (C₃-C₆) aliphatic mono- or di-ethers of ethylene glycol or glycerol, and cosolvents, including, but not limited to, diethylene glycol monobutyl ether, ethylene glycol monobutyl ether, propylene glycol monobutyl ether, and 2,2,4-trimethyl-1,3,-pentane diol monoisobutylate, may be added to the prepolymers before curing into the final polymer. Plasticizers result in a more flexible cured polymer or cured polymer foam, while cosolvents are useful in producing clear cured polymer coatings. In addition to plasticizers, in another embodiment, sebacic acid is used in addition to a first polyacid. The addition of the sebacic acid will also result in a more flexible final cured polymer, with flexibility generally increasing with the concentration of sebacic acid.

When isocyanate is used with a glycerol-based prepolymer, a polyurethane foam is formed under ambient conditions. The isocyanate-catalyzed polyurethane cured polymer foam increases in rigidity as the concentration of isocyanate is increased. Additionally, the isocyanate-catalyzed polyurethane cured polymer may be used as an adhesive or coating by curing at temperatures from about 130° C. to about 250° C.; and preferably from about 140° C. to about 160° C. when used on metals.

### EXAMPLES

The following Examples help to illustrate embodiments of the present invention.

For each of the following examples, the following definitions apply: percentages are weight percents (wt %); ratios are molar ratios. The following units are used, unless otherwise noted: grams (g); milliliters (mL); centipoises (cps); minutes (min); hours (hr); and degrees Celsius (° C.).

For each example disclosing viscosity, the viscosity was measured by first calibrating a Pasteur pipette by measuring the time necessary for a fixed quantity of a standardized glycerol in water solution of known viscosity to drain from the pipette. The pipette was cleaned and a solution of 33 wt % prepolymer in deionized water was prepared. A fixed quantity of the solution was then placed in the Pasteur pipette and the time necessary for the solution to fully drain from the pipette was measured. The viscosity was calculated by comparing the time required for the solution to pass through the pipette with the time required for the standardized glycerol in water to pass through the same pipette.

For each example disclosing glass transition temperatures, unless otherwise noted, the glass transition temperatures were calculated using a differential scanning calorimeter.

BAYHYDUR 302 (Bayer Material Science, Pittsburgh, Pa.), used in Examples 21 and 22, is a water-dispersible solvent-free poly-isocyanate crosslinking agent for use in two-component waterborne polyurethane coatings.

### Example 1

### Preparation of a Glycerol/Citric Acid Prepolymer

Samples of a glycerol/citric acid prepolymer were prepared by the following method. 4.04 g glycerol and 8.09 g anhydrous citric acid (approximately 1:1 molar ratio) were added to a 20 mL PYREX vial and mixed together. The vial was flushed with nitrogen for one (1) minute and then heated in a 145° C. oil bath at atmospheric pressure for three (3) hours. After three hours, the vial was removed from the oil bath and cooled to room temperature. The resulting prepolymer was clear and glassy with a viscosity of 6 cps.

### Example 2

### Preparation of a Glycerol/Citric Acid Prepolymer with Varied Reaction Times

Samples of a glycerol/citric acid prepolymer were prepared by the following method. 60.69 g glycerol and 140.55 g anhydrous citric acid (approximately 1:1 molar ratio) were added to a 150 mL Erlenmeyer flask and mixed together. The vial was flushed with nitrogen for one (1) minute and then heated in a 160° C. oil bath at atmospheric pressure with magnetic stirring. Samples were taken in ten (10) minute increments from twenty (20) minutes after heating was begun to eighty (80) minutes after heating was begun. Glass transition temperatures were calculated for each sample. As reaction time increased, the glass transition temperature increased. The results appear in Table 1.

TABLE 1
Glycerol/Citric Acid Prepolymer (1:1 Molar Ratio) Glass Transition
Temperatures at Varied Reaction Times in a 160° C. Oil Bath

| | Time (min) | | | | | | |
|---|---|---|---|---|---|---|---|
| | 20 | 30 | 40 | 50 | 60 | 70 | 80 |
| Tg (° C.) | −23.98 | −11.16 | 2.35 | 11.96 | 17.11 | 12.54 | 18.74 |

### Example 3

### Preparation of a Glycerol/Citric Acid Cured Polymer

The glycerol/citric acid prepolymers of Example 2 were heated in a differential scanning calorimeter to obtain their glass transition temperatures. Each sample was heated from −30° C. to 250° C. at a constant temperature increase of 10° C./min. (See Example 2, Table 1.) The resulting cured polymer samples were then retested using a differential scanning calorimeter to determine the glass transition temperatures of the cured polymer. The results appear in Table 2.

TABLE 2
Glycerol/Citric Acid Cured Polymer (1:1 Molar Ratio) Glass Transition
Temperatures After Curing at 250° C.

| | Time (min) | | | | | | |
|---|---|---|---|---|---|---|---|
| | 20 | 30 | 40 | 50 | 60 | 70 | 80 |
| Prepolymer Tg | −23.98 | −11.16 | 2.35 | 11.96 | 17.11 | 12.54 | 18.74 |
| (° C.) | | | | | | | |
| Cured Polymer Tg | 141.12 | 127.82 | 119.29 | 127.19 | 124.94 | 106.09 | 119.01 |
| (° C.) | | | | | | | |

### Example 4

### Preparation of a Solketal/Citric Acid Prepolymer

Samples of a solketal/citric acid prepolymer were prepared by the following method. 5.61 g solketal and 8.09 g anhydrous citric acid (approximately 1:1 molar ratio) were added to a 20 mL PYREX vial and mixed together. The vial was flushed with nitrogen for one (1) minute and then heated in a 140° C. oil bath at atmospheric pressure for three (3) hours. After three hours, the vial was removed from the oil bath and cooled to room temperature. The prepolymer was light brown and glassy with a viscosity of 14 cps.

### Example 5

### Preparation of a Solketal/Citric Acid/Sulfuric Acid Prepolymer

The procedure detailed in Example 4 was repeated with 5.60 g solketal and 8.30 g anhydrous citric acid. In addition, before the mixture was heated, 0.017 g of 98% sulfuric acid was added to the vial. The resulting prepolymer was brown and insoluble in water.

### Example 6

### Preparation of a Glycerol/Maleic Acid Prepolymer

Samples of a glycerol/maleic acid prepolymer were prepared by the following method. 3.97 g glycerol and 7.46 g maleic acid (approximately 1:1 molar ratio) were added to a 20 mL PYREX vial and mixed together. The vial was flushed with nitrogen for one (1) minute and then heated in a 145° C. oil bath at atmospheric pressure for three (3) hours. After three hours, the vial was removed from the oil bath and cooled to room temperature. The resulting prepolymer was clear and glassy with a viscosity of 6 cps.

### Example 7

### Preparation of a Glycerol/Fumaric Acid Prepolymer and Cured Polymer

Samples of a glycerol/fumaric acid prepolymer were prepared by the following method. 32.00 g glycerol and 58.00 g fumaric acid (approximately 1:1 molar ratio) were added to a 250 mL Erlenmeyer flask and mixed together. The flask was flushed with nitrogen for one (1) minute. The flask was immersed in a 200° C. oil bath at atmospheric pressure, with stirring, for three (3) hours. After three (3) hours, the flask was removed from the oil bath and the residual white liquid was poured on to a TEFLON sheet and allowed to cool to room temperature. The cooled prepolymer was weighed and the mixture recorded a total weight loss of 12.55 g, indicating a 67% conversion rate. After cooling, the prepolymer was rigid and slightly tacky.

The cooled polymer was then heated in a differential scanning calorimeter to obtain its glass transition temperature. A sample was heated from −30° C. to 250° C. at a constant temperature increase of 10° C./min. The resulting cured polymer sample was then retested using the differential scanning calorimeter to determine the glass transition temperature of the cured polymer. The prepolymer had a glass transition temperature of 55.03° C. and the cured polymer had a glass transition temperature of 71.55° C.

### Example 8

### Preparation of Glycerol/Citric Acid Prepolymer

Samples of a glycerol/anhydrous citric acid prepolymer were prepared by the following method. 21.56 g glycerol and 39.01 g anhydrous citric acid (approximately 1.15:1 molar ratio) were added to a 200 mL Erlenmeyer flask and mixed together. The flask was flushed with nitrogen for one (1) minute. The flask was immersed in a 140° C. oil bath at atmospheric pressure, with stirring, for one (1) hour. After one (1) hour, the flask was removed from the oil bath and the prepolymer was allowed to cool to room temperature.

### Example 9

### Preparation of Glycerol/Citric Acid Prepolymer

Samples of a glycerol/anhydrous citric acid prepolymer were prepared by the following method. 39.88 g glycerol and 39.87 g anhydrous citric acid (approximately 2.09:1 molar ratio) were added to a 200 mL Erlenmeyer flask and mixed together. The flask was flushed with nitrogen for one (1) minute. The flask was immersed in a 140° C. oil bath at atmospheric pressure, with stirring, for one (1) hour. After one (1) hour, the flask was removed from the oil bath and the prepolymer was allowed to cool to room temperature.

### Example 10

### Preparation of Glycerol/Citric Acid Prepolymer

Samples of a glycerol/anhydrous citric acid prepolymer were prepared by the following method. 360.8 g of glycerol were heated to 135° C. in a PYREX dish on hot plate. The glycerol was magnetically stirred and under a nitrogen pad at atmospheric pressure. When the glycerol reached 135° C., 683 g of anhydrous citric acid (approximately 1.1:1 molar ratio) were added. The mixture was reheated to 135° C. over a period of thirty (30) minutes. After reaching 135° C., the temperature was maintained for twenty (20) minutes. The mixture was then cooled to room temperature.

### Example 11

### Preparation of a Glycerol/Citric Acid Prepolymer

Samples of a glycerol/anhydrous citric acid prepolymer were prepared by the following method. 357.0 g of glycerol were heated to 135° C. in a PYREX dish on hot plate. The glycerol was magnetically stirred and under a nitrogen pad at atmospheric pressure. When the glycerol reached 135° C., 494.8 g of anhydrous citric acid (approximately 1.5:1 molar ratio) were added. The mixture was reheated to 135° C. over a period of twenty-five (25) minutes. After reaching 135° C., the temperature was maintained for twenty (20) minutes. The mixture was then cooled to room temperature.

### Example 12

### Preparation of a Glycerol/Citric Acid Cured Polymer Foam

A sample of 1.69 g of the glycerol/citric acid prepolymer as prepared in Example 1 was heated at approximately 204° C. at atmospheric pressure in an oven for ten (10) minutes. The cured polymer was cooled. The cured polymer weighed 1.53 g and was a clear, semi-rigid foam with a density of 0.35 g/cc.

### Example 13

### Preparation of a Glycerol/Citric Acid Cured Polymer Foam

A sample of 1.77 g of the glycerol/citric acid prepolymer as prepared in Example 8 was heated at approximately 182° C. at atmospheric pressure in an oven for 30 minutes. The cured polymer was cooled. The cured polymer weighed 1.78 g and was a rigid foam. The foam softened to a semi-rigid foam after continuous exposure to atmospheric moisture for a period of two (2) weeks.

### Example 14

### Preparation of a Glycerol/Citric Acid Cured Polymer Foam

A sample of 1.78 g of the glycerol/citric acid prepolymer as prepared in Example 9 was heated at approximately 182° C. at atmospheric pressure in an oven for 30 minutes. The cured polymer was cooled. The cured polymer formed a hard foam.

### Example 15

### Preparation of a Glycerol/Citric Acid Cured Polymer Foam

A mixture of 3.03 g of the glycerol/citric acid prepolymer as prepared in Example 8 and 0.6 g glycerol was heated at approximately 182° C. at atmospheric pressure in an oven for thirty (30) minutes. The cured polymer was cooled. The cured polymer weighed 3.05 g and had formed a clear, small-cell hard foam. The foam softened to a soft foam after continuous exposure to atmospheric moisture for a period of two (2) weeks.

### Example 16

### Preparation of a Glycerol/Citric Acid Cured Polymer Foam

A mixture of 1.41 g of the glycerol/citric acid prepolymer as prepared in Example 1 and 0.26 g water was heated at approximately 204° C. at atmospheric pressure in an oven for ten (10) minutes. The cured polymer was cooled. The cured polymer weighed 1.13 g and had formed a clear, rigid foam with a density of 0.19 g/cc.

### Example 17

### Preparation of a Glycerol/Citric Acid Cured Polymer Glass Coating

A homogeneous mixture of 6.75 of the glycerol/citric acid prepolymer as prepared in Example 8 and 2.89 g of diethylene glycol monobutyl ether was prepared by stirring at room temperature. Using a drawdown blade, a 1.5 mm wet film of the homogeneous mixture was applied to a glass slide. The coated glass slide was heated at 160° C. in an oven for twenty (20) minutes. The resulting cured polymer coating was clear and non-tacky.

### Example 18

### Preparation of a Glycerol/Citric Acid Cured Polymer Adhesive

A small amount of the glycerol/citric acid prepolymer as prepared in Example 1 was placed between two flat metal strips and two flat wooden strips. Separately, a small amount of the glycerol/citric acid prepolymer as prepared in Example 8 was placed between two flat metal strips and two flat wooden strips. The strips were placed into a 191° C. oven and allowed to cure for twenty (20) minutes. The strips were then removed from the oven and allowed to cool to room temperature. After cooling, all strips adhered to each other. Attempts were made to separate each set of strips. The metal strips adhered with the cured polymer made from the glycerol/citric acid prepolymer as prepared in Example 1 were difficult to separate by twisting. The metal strips adhered with the cured polymer made from the glycerol/citric acid prepolymer as prepared in Example 8 were somewhat difficult to separate by twisting. Neither the wooden strips adhered with the cured polymer made from the glycerol/citric acid prepolymer as prepared in Example 1 nor the wooden strips adhered with the cured polymer made from the glycerol/citric acid prepolymer as prepared in Example 8 could be separated by twisting.

### Example 19

### Resistance of a Glycerol/Citric Acid Cured Polymer Adhesive to Common Solvents

Using the method of Example 18, three sets of adhered metal strips and three sets of adhered wooden strips were made by adhering two strips with a small amount of the glycerol/citric acid prepolymer as prepared in Example 1. One sample from each set (one adhered metal strip set and one adhered wooden strip set) was placed in a 1 normal solution of sodium hydroxide, deionized water, and a 1 normal solution of hydrochloric acid, respectively. The cured polymer adhesive adhering the metal strips dissolved in five (5) minutes in the 1 normal sodium hydroxide solution. The cured polymer adhesive adhering the wooden strips dissolved in ten (10) minutes in the 1 normal sodium hydroxide solution. The cured polymer adhesive adhering both the metal and wooden strips dissolved after forty-five (45) minutes in the deionized water. The cured polymer adhesive adhering both the metal and wooden strips did not dissolve in the 1 normal hydrochloric acid solution.

### Example 20

### Resistance of a Glycerol/Citric Acid Cured Polymer Adhesive to Common Solvents

Two sets of adhered metal strips were made by adhering two metal strips with a small amount of the glycerol/citric acid prepolymer as prepared in Example 1. The strips were placed into a 204° C. oven and allowed to cure for thirty (30) minutes. The strips were then removed from the oven and allowed to cool to room temperature. After cooling, both sets of metal strips had adhered to each other and were difficult to separate by twisting. One set of adhered metal strips was placed in a 1 normal sodium hydroxide solution and the other set of adhered metal strips was placed in deionized water. The cured polymer adhesive on the set of adhered metal strips in the 1 normal sodium hydroxide solution dissolved after seventy-five (75) minutes. The cured polymer adhesive on the set of adhered metal strips in deionized water did not dissolve after two (2) days of continual submersion.

### Example 21

### Preparation of a Glycerol/Citric Acid Cured Polymer Metal Coating

A homogeneous mixture of 70.1 g of the glycerol/citric acid prepolymer as prepared in Example 11, 30 g of diethylene glycol monobutyl ether, and 1.43 g BAYHYDUR 302 (Bayer Material Science, Pittsburgh, Pa.), a polyisocyanate crosslinking agent, was prepared by stirring at room temperature. The mixture foamed slightly. Using a drawdown blade, a 3 mm wet film of the homogeneous mixture was applied to a metal panel. The coated metal panel was air-dried for fifteen (15) minutes and then was heated at 138° C. in an oven for fifteen (15) minutes. The resulting cured polymer coating was clear and non-tacky.

### Example 22

### Preparation of a Glycerol/Citric Acid Polyurethane Foam Using a Polyisocyanate Crosslinking Agent

Three samples of a mixture of prepolymer and BAYHYDUR 302 (Bayer Material Science, Pittsburgh, Pa.), a polyisocyanate crosslinking agent, were prepared. For the first sample, 98.6 g of the prepolymer as prepared in Example 10 were mixed with 62.5 g BAYHDUR 302. For the second sample, 101.5 g of the prepolymer as prepared in Example 10 were mixed with 30.33 g BAYHDUR 302. For the third sample, 49.69 g of the prepolymer as prepared in Example 11 were mixed with 16.6 g BAYHDUR 302. Each sample was stirred at room temperature for thirty (30) seconds and the volume of foam was measured. The first sample produced approximately four (4) liters of foam. The foam was initially very brittle, but, upon standing, hardened into a very hard foam. The second sample produced approximately one (1) liter of foam. The foam was firm. The third sample produced about one (1) liter of foam. The foam was flexible and had a low density.

### Example 23

### Preparation of a Glycerol/Citric Acid Cured Polymer Coating Using a para-Toluene Sulfonic Acid Catalyst

A glycerol/citric acid prepolymer as prepared in Example 1 was made. Based on weight loss, the polymer conversion rate for the prepolymer was approximately 43%. After the prepolymer was cooled to room temperature, it was mixed with deionized water to form a 64 wt % solids solution. Samples of the solution were taken to test the effect of varying additions of para-toluene sulfonic acid (pTSA) catalyst on the required reaction time for the cured polymer. One sample was used as a control without pTSA added. pTSA levels of 1, 5, and 10 wt % (solids pTSA:solids solution) were evaluated. After mixing the pTSA into the prepolymer solution, a 3 mm wet layer of each formulation was applied to black glass using a drawdown blade. The applications were then cured at 177° C. in an oven for five (5) minutes. The films were removed from the oven and allowed to cool to room temperature. Spot tests using water and methyl ethyl ketone (MEK) were used to test film resistance to dissolution after eighteen (18) hours. Resistance to dissolution was measured on a scale of 1 to 10 with 1 representing no resistance to the solvent and 10 representing complete resistance to the solvent. The results are summarized in Table 3.

TABLE 3
Resistance of a Glycerol/Citric Acid pTSA Cured
Polymer to Resist Dissolution

| pTSA Addition | Water | MEK |
|---|---|---|
| (solids/solids) | Resistance | Resistance |
| 0.00% | 0 | 10 |
| 1.00% | 2 | 10 |
| 5.00% | 8 | 10 |
| 10.00% | 9 | 10 |

### Example 24

### Preparation of a Glycerol/Citric Acid Cured Polymer Coating Using a Para-Toluene Sulfonic Acid Catalyst

Example 23 was repeated two additional times using different curing temperatures. When the samples were cured for five (5) minutes at 60° C., the glycerol/citric acid prepolymer did not cure into the final cured polymer. When the samples were cured for five (5) minutes at 204° C., the glycerol/citric acid prepolymer cured into a final cured polymer. The dissolution test was repeated. After curing at 204° C., the 1.00% pTSA addition showed increased resistance to dissolution, and the 5.00% and 10.00% pTSA additions showed no signs of dissolution. None of the cured samples dissolved in MEK.

### Example 25

### Preparation of a Glycerol/Citric Acid/Fumaric Acid Prepolymer and Cured Polymer

Samples of a glycerol/citric acid/fumaric acid prepolymer were prepared by the following method. 30.73 g glycerol, 29.04 g anhydrous citric acid, and 32.04 g fumaric acid (approximately 1:0.5:0.5 molar ratio) were added to a 250 mL Erlenmeyer flask and mixed together. The flask was flushed with nitrogen for one (1) minute. The flask was immersed in a 190° C. oil bath at atmospheric pressure, with stirring, for twenty (20) minutes, then transferred to a 160° C. oil bath at atmospheric pressure, with stirring, for thirty-five (35) minutes. Then the flask was removed from the oil bath and allowed to cool to room temperature.

The cooled polymer was then heated in a differential scanning calorimeter to obtain its glass transition temperature. A sample was heated from −30° C. to 250° C. at a constant temperature increase of 10° C./min. The resulting cured polymer sample was then retested using the differential scanning calorimeter to determine the glass transition temperature of the cured polymer. The prepolymer had a glass transition temperature of 55.94° C. and the cured polymer had a glass transition temperature of 104.65° C.

### Example 26

### Preparation of a Glycerol/Citric Acid/Sebacic Acid Prepolymer

Samples of a glycerol/citric acid/sebacic acid prepolymer were prepared by the following method. First, 220 g glycerol was added to a 1.5 L beaker and heated in a 200° C. oil bath while being magnetically stirred. After the glycerol reached 200° C., 224 g sebacic acid were added and magnetically stirred at 200° C. for thirty (30) minutes. After thirty (30) minutes, 200.42 g citric acid were added to the mixture. After the citric acid addition, the temperature was reduced to 160° C. and the mixture was magnetically stirred at 160° C. for thirty (30) minutes. After thirty (30) minutes, the polymer was cooled and weighed. Based on weight loss of the cooled polymer, the conversion rate was 50.6%.

### Example 27

### Preparation of a Glycerol/Fumaric Acid/Sebacic Acid Prepolymer

Samples of a glycerol/fumaric acid/sebacic acid prepolymer were prepared by the following method. First, 256 g glycerol, 411.52 g fumaric acid, and 126.24 g sebacic acid were heated in an oil bath to 200° C. The mixture was heated for fifty (50) minutes and then cooled. Based on weight loss of the cooled polymer, the conversion rate was 50.6%.

It will be appreciated by those skilled in the art that changes could be made to the embodiments and examples described above without departing from the broad inventive concept thereof. It is understood, therefore, that this invention is not limited to the particular embodiments and examples disclosed, but is instead intended to cover modifications within the spirit and scope of the present invention as defined by the appended claims.

1. A crosslinked polycondensation product of:
(a) one or more polyols selected from the group consisting of: (1) polyols with three or more hydroxyl groups, (2) acetal forms of (1), and (3) mixtures thereof, and
(b) one or more polyacids selected from the group consisting of: (1) polyacids with two or more carboxylic groups, (2) anhydrides of (1), (3) esters of (1), and (4) mixtures thereof;
in which the molar ratio of polyol to polyacid is from about 1:3 to about 3:1; and the crosslinked polycondensation product is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or by a glass transition temperature from about 50° C. to about 150° C.

2. The crosslinked polycondensation product of claim 1 wherein the polyol is selected from the group consisting of: (1) linear (C₁-C₆) trihydroxy alkanes, (2) cyclic (C₁-C₆) trihydroxy alkanes, (3) linear (C₂-C₆) trihydroxy alkenes, (4) cyclic (C₂-C₆) trihydroxy alkenes, (5) acetal forms of (1)-(4), and (6) mixtures thereof.

3. The crosslinked polycondensation product of claim 1 wherein the polyacid is selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof.

4. The crosslinked polycondensation product of claim 1 wherein the polyol is glycerol and the polyacid is selected from (1) citric acid, (2) sebacic acid, (3) fumaric acid, (4) ester forms of (1)-(3) and (5) mixtures thereof.

5. The crosslinked polycondensation product of claim 1 wherein the product is self-crosslinked with the polyol or the polyacid without the addition of a further crosslinking agent or a polymerization catalyst.

6. The crosslinked polycondensation product of claim 1 wherein the polycondensation product consists essentially of the product of the polyol and the polyacid.

7. A method for preparing a crosslinked polyester comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1;
(b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer;
(c) optionally mixing the low molecular weight prepolymer with a modification compound selected from the group consisting of: (1) polymer additives, (2) plasticizers, (3) foam blowing agents, and (4) mixtures thereof, to form a second mixture;
(d) reacting either (1) the low molecular weight prepolymer or (2) the second mixture by heating at a pressure at or above about one (1) atmosphere and at a temperature from about 175° C. to about 400° C. for a period of time from about three (3) seconds to about sixty (60) minutes to form the crosslinked polyester.

8. The method of claim 7 wherein the crosslinked polyester is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or a glass transition temperature from about 50° C. to about 150° C.

9. The method of claim 7 wherein the polyol is selected from the group consisting of: (1) linear (C₁-C₆) trihydroxy alkanes, (2) cyclic(C₁-C₆) trihydroxy alkanes, (3) linear (C₂-C₆) trihydroxy alkenes, (4) cyclic (C₂-C₆) trihydroxy alkenes, (5) acetal forms of (1)-(4), and (6) mixtures thereof.

10. The method of claim 7 wherein the polyacid is selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof.

11. The method of claim 7 wherein the crosslinked polyester is self-crosslinked with the polyol or the polyacid without the addition of a further crosslinking agent or a polymerization catalyst and further wherein the polyester consists essentially of the product of the polyol and the polyacid.

12. A method of making a crosslinked polyester comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1;
(b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer;
(c) optionally mixing the low molecular weight prepolymer with a modification compound selected from the group consisting of: (1) polymer additives, (2) plasticizers, (3) foam blowing agents, and (4) mixtures thereof, to form a second mixture;
(d) mixing either (1) the low molecular weight prepolymer or (2) the second mixture with a crosslinking agent and curing at a pressure at or above about one (1) atmosphere and at a temperature from about 20° C. to about 130° C. for a period of time from about thirty (30) seconds to about sixty (60) minutes to form the crosslinked polyester.

13. The method of claim 12 wherein the crosslinked polyester is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or a glass transition temperature from about 50° C. to about 150° C.

14. The method of claim 12 wherein the polyol is selected from the group consisting of: (1) linear (C₁-C₆) trihydroxy alkanes, (2) cyclic(C₁-C₆) trihydroxy alkanes, (3) linear (C₂-C₆) trihydroxy alkenes, (4) cyclic (C₂-C₆) trihydroxy alkenes, (5) acetal forms of (1)-(4), and (6) mixtures thereof.

15. The method of claim 12 wherein the polyacid is selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof.

16. The method of claim 12 wherein the crosslinking agent is selected from the group consisting of: (1) aromatic diisocyanates, (2) aliphatic diisocyanates, (3) polymeric diisocyanates, (4) cycloaliphatic diepoxides, (5) aromatic diepoxides, (6) diepoxides with oxyalkyl backbones, (7) 2,2,4-trimethyl-1,3-pentane diol monoisobutylate, (8) glycerin, (9) trimethylol propane, and (10) mixtures thereof.

17. A method of making a crosslinked polyester comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1;
(b) reacting the first mixture at a pressure at or above about one (1) atmosphere and at a temperature from about 80° C. to about 250° C. for a period of time from about fifteen (15) minutes to about three hundred (300) minutes to form a low molecular weight prepolymer;
(c) optionally mixing the low molecular weight prepolymer with a modification compound selected from the group consisting of: (1) polymer additives, (2) plasticizers, (3) foam blowing agents, and (4) mixtures thereof, to form a second mixture;
(d) mixing either (1) the low molecular weight prepolymer or (2) the second mixture with a polymerization catalyst and curing at a pressure at or above about one (1) atmosphere and at a temperature from about 130° C. to about 250° C. for a period of time from about thirty (30) seconds to about sixty (60) minutes to form the crosslinked polyester.

18. The method of claim 17 wherein the crosslinked polyester is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or a glass transition temperature from about 50° C. to about 150° C.

19. The method of claim 17 wherein the polyol is selected from the group consisting of: (1) linear (C₁-C₆) trihydroxy alkanes, (2) cyclic(C₁-C₆) trihydroxy alkanes, (3) linear (C₂-C₆) trihydroxy alkenes, (4) cyclic (C₂-C₆) trihydroxy alkenes, (5) acetal forms of (1)-(4), and (6) mixtures thereof.

20. The method of claim 17 wherein the polyacid is selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof.

21. The method of claim 17 wherein the polymerization catalyst is selected from the group consisting of: (1) sulfuric acid, (2) phenylsulfonic acid, (3) benzene sulfonic acid, (4) para-toluene sulfonic acid, and (4) mixtures thereof.

22. A method of forming a shaped polyester article comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1;
(b) reacting the first mixture at a pressure at or above about one (1) atmosphere and at a temperature from about 80° C. to about 250° C. for a period of time from about fifteen (15) minutes to about three hundred (300) minutes to fourm a low molecular weight prepolymer;
(c) cooling the resulting low molecular weight prepolymer to ambient conditions;
(d) heating the cooled low molecular weight prepolymer to a temperature above the gel point of the prepolymer until the low molecular weight prepolymer is flowable;
(e) optionally mixing the flowable low molecular weight prepolymer with a modification compound selected from the group consisting of: (1) polymer additives, (2) plasticizers, (3) foam blowing agents, and (4) mixtures thereof to form a polymer mixture; and
(f) reacting either (1) the flowable low molecular weight prepolymer or (2) the polymer mixture by heating at a pressure at or above about one (1) atmosphere and at a temperature from about 175° C. to about 400° C. for a period of time from about three (3) seconds to about sixty (60) minutes in a mold, extruder, film casting equipment, spray gun, or other shape-forming or thermoforming equipment to form the shaped polyester article.

23. The method of claim 22 wherein the shaped polyester article is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or a glass transition temperature from about 50° C. to about 150° C.

24. The method of claim 22 wherein the polyol is selected from the group consisting of: (1) linear (C₁-C₆) trihydroxy alkanes, (2) cyclic(C₁-C₆) trihydroxy alkanes, (3) linear (C₂-C₆) trihydroxy alkenes, (4) cyclic (C₂-C₆) trihydroxy alkenes, (5) acetal forms of (1)-(4), and (6) mixtures thereof.

25. The method of claim 22 wherein the polyacid is selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof.

26. The method of claim 22 wherein the flowable low molecular weight prepolymer is mixed with a modification compound selected from the group consisting of: (1) diethylene glycol monobutyl ether, (2) ethylene glycol monobutyl ether, (3) propylene glycol monobutyl ether, (4) carbon dioxide, (5) water vapor, (6) carbonate salts, (7) gaseous hydrocarbons, (8) halogenated hydrocarbons, (9) alcohols, and (10) mixtures thereof.

27. A method of forming a shaped polyester article comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1;
(b) reacting the first mixture from step (a) at a pressure at or above about one (1) atmosphere and at a temperature from about 80° C. to about 250° C. for a period of time from about fifteen (15) minutes to about three hundred (300) minutes to form a low molecular weight prepolymer;
(c) cooling the resulting low molecular weight prepolymer to ambient conditions; and
(d) heating the cooled low molecular weight prepolymer to a temperature above the gel point of the prepolymer until the low molecular weight prepolymer is flowable;
(e) optionally mixing the flowable low molecular weight prepolymer with a modification compound selected from the group consisting of: (1) polymer additives, (2) plasticizers, (3) foam blowing agents, and (4) mixtures thereof to form a polymer mixture; and
(f) reacting either (1) the flowable low molecular weight prepolymer or (2) the polymer mixture with a crosslinking agent at a pressure at or above about one (1) atmosphere and at a temperature from about 20° C. to about 130° C. for a period of time from about thirty (30) seconds to about sixty (60) minutes in a mold, extruder, film casting equipment, spray gun, or other shape-forming or thermoforming equipment to form the shaped polyester article.

28. The method of claim 27 wherein the shaped polyester article is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or a glass transition temperature from about 50° C. to about 150° C.

29. The method of claim 27 wherein the polyol is selected from the group consisting of: (1) linear (C₁-C₆) trihydroxy alkanes, (2) cyclic(C₁-C₆) trihydroxy alkanes, (3) linear (C₂-C₆) trihydroxy alkenes, (4) cyclic (C₂-C₆) trihydroxy alkenes, (5) acetal forms of (1)-(4), and (6) mixtures thereof.

30. The method of claim 27 wherein the polyacid is selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof.

31. The method of claim 27 wherein the flowable low molecular weight prepolymer is mixed with a modification compound selected from the group consisting of: (1) diethylene glycol monobutyl ether, (2) ethylene glycol monobutyl ether, (3) propylene glycol monobutyl ether, (4) carbon dioxide, (5) water vapor, (6) carbonate salts, (7) gaseous hydrocarbons, (8) halogenated hydrocarbons, (9) alcohols, and (10) mixtures thereof.

32. The method of claim 27 wherein the crosslinking agent is selected from the group consisting of: (1) aromatic diisocyanates, (2) aliphatic diisocyanates, (3) polymeric diisocyanates, (4) cycloaliphatic diepoxides, (5) aromatic diepoxides, (6) diepoxides with oxyalkyl backbones, (7) 2,2,4-trimethyl-1,3-pentane diol monoisobutylate, (8) glycerin, (9) trimethylol propane, and (10) mixtures thereof.

33. A method of forming a shaped polyester article comprising:
(a) mixing one or more polyols selected from the group consisting of: (1) polyols with three or more hydroxyl groups, (2) acetal forms of (1), and (3) mixtures thereof with one or more polyacids selected from the group consisting of: (1) polyacids with two or more carboxylic groups, (2) anhydrides of (1), (3) esters of (1), and (4) mixtures thereof to form a first mixture; wherein the first mixture has a molar ratio of polyol to polyacid from about 1:3 to about 3:1;
(b) reacting the first mixture from step (a) at a pressure at or above about one (1) atmosphere and at a temperature from about 80° C. to about 250° C. for a period of time from about fifteen (15) minutes to about three hundred (300) minutes to form a low molecular weight prepolymer;
(c) cooling the resulting low molecular weight prepolymer to ambient conditions;
(d) heating the cooled low molecular weight prepolymer to a temperature above the gel point of the prepolymer until the low molecular weight prepolymer is flowable;
(e) optionally mixing the flowable low molecular weight prepolymer with a modification compound selected from the group consisting of: (1) polymer additives, (2) plasticizers, (3) foam blowing agents, and (4) mixtures thereof to form a polymer mixture; and
(f) reacting either (1) the flowable low molecular weight prepolymer or (2) the polymer mixture with a polymerization catalyst at a pressure at or above about one (1) atmosphere and at a temperature from about 130° C. to about 250° C. for a period of time from about thirty (30) seconds to about sixty (60) minutes in a mold, extruder, film casting equipment, spray gun, or other shape-forming or thermoforming equipment to form the shaped polyester article.

34. The method of claim 33 wherein the shaped polyester article is highly-crosslinked, as evidenced by either general insolubility in one or more solvents selected from the group consisting of: (1) water, (2) acetone, (3) methyl ethyl ketone, (4) tetrahydrofuran, (5) dimethylformamide, and (6) dichloromethane, or a glass transition temperature from about 50° C. to about 150° C.

35. The method of claim 33 wherein the polyol is selected from the group consisting of: (1) linear (C₁-C₆) trihydroxy alkanes, (2) cyclic(C₁-C₆) trihydroxy alkanes, (3) linear (C₂-C₆) trihydroxy alkenes, (4) cyclic (C₂-C₆) trihydroxy alkenes, (5) acetal forms of (1)-(4), and (6) mixtures thereof.

36. The method of claim 33 wherein the polyacid is selected from the group consisting of: (1) oxalic acid, (2) succinic acid, (3) adipic acid, (4) maleic acid, (5) citric acid, (6) cis-aconitic acid, (7) isocitric acid, (8) alpha-ketoglutaric acid, (9) fumaric acid, (10) axalacetic acids, (11) phthalic acid, (12) terephthalic acid, (13) isophthalic acid, (14) sebacic acid, (15) cyclohexyl dicarboxylic acid, (16) positional isomers of (15), (17) napthyl dicarboxylic acids, (18) positional isomers of (17), (18) trimelletic acid, (19) anhydride forms of (1)-(18), (20) ester forms of (1)-(18), and (21) mixtures thereof.

37. The method of claim 33 wherein the flowable low molecular weight prepolymer is mixed with a modification compound selected from the group consisting of: (1) diethylene glycol monobutyl ether, (2) ethylene glycol monobutyl ether, (3) propylene glycol monobutyl ether, (4) carbon dioxide, (5) water vapor, (6) carbonate salts, (7) gaseous hydrocarbons, (8) halogenated hydrocarbons, (9) alcohols, and (10) mixtures thereof.

38. The method of claim 33 wherein the polymerization catalyst is selected from the group consisting of: (1) sulfuric acid, (2) phenylsulfonic acid, (3) benzene sulfonic acid, (4) para-toluene sulfonic acid, and (4) mixtures thereof.
